(19) United States
(12) Patent Application Publication
(10) Pub. No.: US 2017/0242805 A1
(43) Pub. Date: Aug. 24, 2017

(54) MODULAR WEARABLE COMPUTING DEVICE

(71) Applicants: LARISSA NIETNER, CAMBRIDGE, MA (US); SCOTT NILL, CAMBRIDGE, MA (US)

(72) Inventors: LARISSA NIETNER, CAMBRIDGE, MA (US); SCOTT NILL, CAMBRIDGE, MA (US)

(21) Appl. No.: 15/506,946

(22) PCT Filed: Aug. 29, 2015
(86) PCT No.: PCT/US15/47621

§ 371 Date: Feb. 27, 2017

Related U.S. Application Data
(60) Provisional application No. 62/044,014, filed on Aug. 29, 2014.

(51) Int. Cl. G06F 13/10; G06F 1/16

(52) U.S. Cl. CPC G06F 13/102; G06F 1/163

(57) ABSTRACT

A wearable computing unit with module connection sites can incorporate many different extension types, such as sensors, indicators or executable code, providing many different functionalities. This allows for combining hardware and computing configurations from different origins. Assembly with instant module connection feedback and integration assistance allows users to customize function with ease. For example, configurations can be selected from a database or shared with other users. Mechanical connectors provide multiple modes of wearing the modular device, including the combination with jewelry. This extends its application to user groups with specific aesthetic expectations.

### CROSS-REFERENCE TO RELATED APPLICATIONS

This application claims the benefit of PPA Ser. No. 62/044,014, filed 2014 Aug. 29 by the present inventors, which is incorporated by reference.

### FIELD

The present invention relates generally to wearable computing and in particular to modular wearable computing devices.

### BACKGROUND

Wearable computers have been known in the art to provide a variety of features. Electronic devices may be worn with proximity to the user and may provide enhanced interaction with the user. Some wearable electronic devices permit different applications for technologies including computers, sensors and mobile communication devices. Such devices may be used for medical applications, fitness, mobile communications, or organizational purposes. A variety of functionality is now covered by wearable electronic devices, and it is possible that reconfigurable hardware is an area of interest. Accordingly, there remains a need for further contributions in this area.

### SUMMARY

A computing unit with module connection sites can incorporate many different extension types, such as sensors, indicators or executable code, providing many different functionalities. This allows for combining hardware and computing configurations from different origins. Assembly with instant module connection feedback and integration assistance allows users to customize function with ease. For example, configurations can be selected from a database or shared with other users. Mechanical connectors provide multiple modes of wearing the modular device, including the combination with jewelry. This extends its application to users with specific aesthetic expectations.

In one embodiment, a computing base has a housing, at least one module connection port, and at least one mechanical connector. In another embodiment, a computing base has at least one module connected to a module connection port, and a decorative element, band, or passive section, such as a bracelet or a necklace, connected to a mechanical connector on the housing, forming a wearable electronic device. In a different embodiment, said module connection port and said mechanical connector can be combined.

Such a module connection port comprises at least one data line, voltage line and ground line. One or more module connection ports can be available on a computing base. In general, the smart base contains at least a master processor and memory that stores readable instructions, which cause the master processor to detect attachment of a new extension module, determine the communication status to the module, and provide output to the user. Additionally, the master processor may be configured to detect the attachment location of the attached extension module.

In one embodiment, the proper attachment location of an extension module may be predetermined prior to attachment to achieve a certain configuration, and said attachment location may be indicated to the user. In another embodiment, possible configurations may be determined based on the module that was connected, and communicated to the user. The user may then select a preferred configuration or functionality, and trigger its implementation. This provides guidance to users, making it easy to reconfigure the system. In one embodiment, the configuration can be shared, making the assembly experience more social.

In a different embodiment, the device may include indicia for interfacing with the user, such as a display. Moreover, the device may include a tactile interface. The computing base may include a battery as a power source. Alternatively, a battery can be contained in an extension module attached to the base. Additionally, the computing base or modules may contain a functional component such as a wireless transceiver, an accelerometer, a temperature sensor, a camera, an indicator, a haptic device, a GPS receiver, a gyroscope, a display, a tactile sensor, a galvanometer, a speaker, or a motor.

### BRIEF DESCRIPTION OF THE DRAWINGS

The present disclosure will be understood more fully from the detailed description given hereinafter and from the accompanying drawings. These drawings show different aspects of the present inventions and, where appropriate, reference numerals illustrating like structures, components, materials and/or elements in different figures are labeled similarly. It is understood that various combinations of the structures, components, and/or elements, other than those specifically shown, are contemplated and are within the scope of the present inventions. Moreover, any of the aspects of the present inventions, and/or embodiments thereof, may be employed alone or in combination with one or more of the other aspects of the present inventions and/or embodiments thereof. For the sake of brevity, certain permutations and combinations are not discussed and/or illustrated separately herein.

FIG. 1 shows a schematic representation of a computing base showing an exemplary arrangement of master processor, memory and module connection port on the computing base.

FIG. 2 shows various exemplary extension modules.

FIG. 2a shows an extension module that contains a sensor.

FIG. 2b shows an extension module that contains an output device.

FIG. 2c shows an extension module that contains machine-readable memory.

FIG. 2d shows an extension module that contains a battery.

FIG. 3 shows a schematic representation of a connection procedure between the compact computing unit and a new expansion module.

FIG. 4 shows an exploded view of an assembled wearable computing device showing the arrangement of the band, the compact computing base, and expansion modules.

FIG. 5 shows an exemplary wearable electronic device and arrangement of components on the wrist of a user.

FIG. 6 shows another exemplary composition of the computing base.

FIG. 7 shows an exploded view of an assembled wearable device and a mode of wearing the same.

FIG. 8 shows another exemplary wearable electronic device and a mode of wearing the same.

FIG. 9 shows a computing base that contains flexible electronics.

FIG. 9a shows an undeformed flexible computing base.

FIG. 9b shows a deformed flexible computing base.

FIG. 10 shows various exemplary module connectors.

FIG. 11 shows a combined mechanical and electrical connection port.

FIG. 12 shows an exemplary feedback system for use in the present invention to provide output to the user in response to a successful connection of an expansion module and the compact computing base.

FIG. 13 shows a schematic representation of the interface between the compact computing base and the expansion modules.

FIG. 14 shows a schematic representation of a connection procedure between the compact computing base and a new expansion module.

FIG. 15 shows a schematic representing the different forms of communication between a host and the computing device.

FIG. 16 shows a schematic representation of different topologies for networks comprising computing devices and other electronic devices.

FIG. 17 shows a schematic representation of a procedure for configuring the device to a desired function.

FIG. 18 shows a schematic representation of a procedure for guiding the assembly of a device.

FIG. 19 shows a schematic representation of a procedure for determining the function of an assembled device.

FIG. 20 shows a schematic representation of a procedure for determining the function of an assembled device.

FIG. 21 shows an additional form of the computing base with a display and multiple connection sites.

FIG. 22 shows two additional forms of bands attached to the device: One forming a bracelet 22a, one forming a second piece of jewelry 22b.

Corresponding reference characters indicate corresponding parts throughout the several views. The exemplary embodiments set forth herein are not to be construed as limiting the scope of the invention in any manner.

### DETAILED DESCRIPTION OF THE INVENTION

The present disclosure will be discussed hereinafter in detail in terms of various exemplary embodiments according to the present disclosure with reference to the accompanying drawings. In the following detailed description, numerous specific details are set forth in order to provide a thorough understanding of the present disclosure. It will be obvious, however, to those skilled in the art that the present disclosure may be practiced without these specific details. In other instances, well-known structures are not shown in detail in order to avoid unnecessary obscuring of the present disclosure.

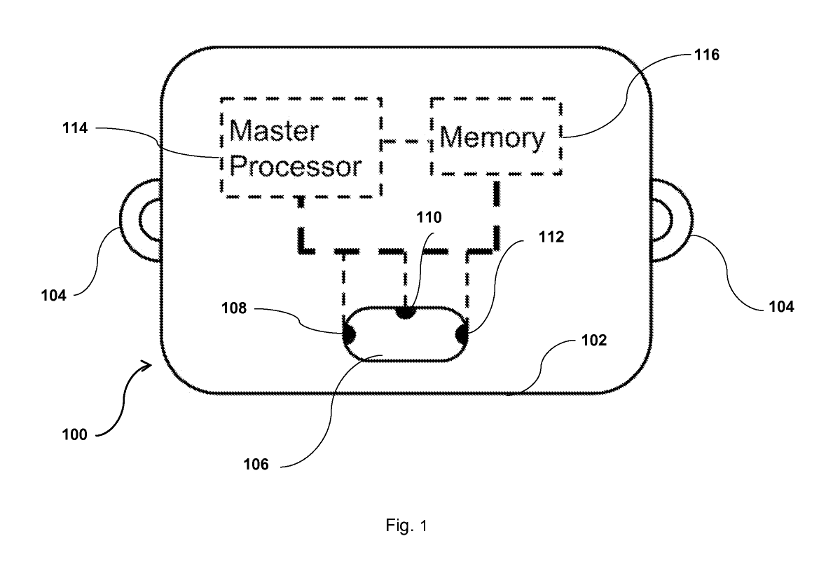

Thus, all of the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring now to the disclosure in more detail, in FIG. 1 there is shown a computing base, compact computing unit, 100 including a housing 102, one or more mechanical connectors 104, and one or more module connection ports 106 which may be having a ground line 108, a power line 110 and a data line 112.

In further detail, the computing base 100 in FIG. 1 contains a master processor, microcontroller or microcomputer 114 and memory 116. Module connection port 106, more specifically its data line; master processor 114 and memory 116 are coupled, or associated, through an electrical bus 118. The electrical bus further includes a voltage line coupled to a power source.

In one embodiment, the computing device supports the addition, removal, and exchange of expansion modules while the computing base remains in operation within a configuration that supports a compact design and requires less energy than many other computing devices known in the art. For example, the bus may be configured as an M-PHY physical layer to support the MiniPro protocol as defined by the Mobile Industry Processor Interface Alliance. On such a framework, the user may be assisted with adding expansion modules to the device.

The master processor 114 may process signals received from sensors coupled to the master processor 114 through the module connection port 106 from expansion modules connected thereto, and it may output signals through integrated signaling devices or external signaling devices, which can also be coupled through module connection port 106.

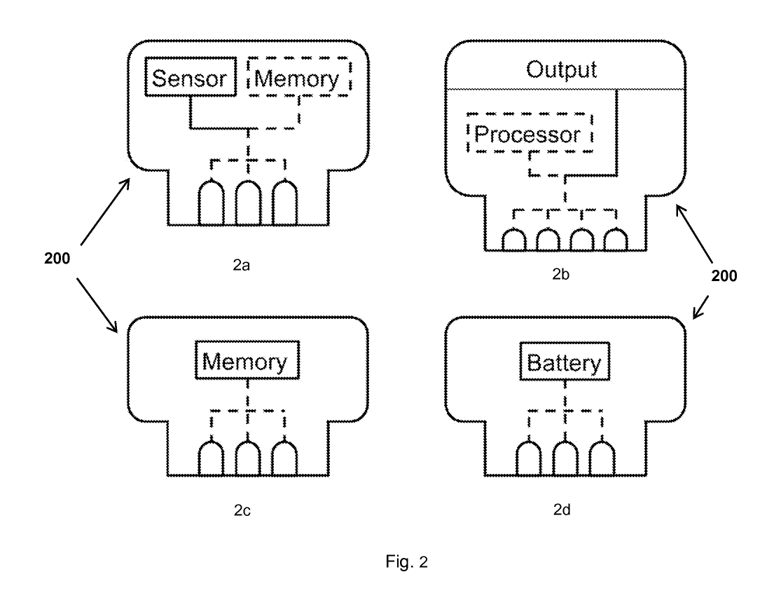

Exemplary embodiments of expansion modules or functional modules are given in FIG. 2. As used herein, the term module, expansion module, or functional module, may refer to, be part of, or include: a housing with a connector to match the at least one module connection port 106 on the computing base 100; stored therein one or more of: a sensor 204; a combinational logic circuit 206; memory storage readable by the computing base 208; a user input device; an output device; a battery as a power source; other suitable components that provide the described functionality; or a combination of some or all of the above, such as in a system-on-chip. The expansion module may also include memory (shared, dedicated, or grouped) that stores code executed by one or more processors. The term sensing module may refer to to an extension module with at least one sensor connected to an electrical bus. In analogy, a user input module may comprise at least one user input device; an electronic logic module may store combinational logic; a memory module may comprise machine readable memory; an output module may comprise at least one output device; and a decorative module may serve decorative purposes. In one embodiment, an extension module may comprise a control circuit. In a particular embodiment, such a control circuit may assist in the assembly by providing feedback to the user, for example about successful attachment. In different embodiments, modules may contain a functional component such as a wireless transceiver, an accelerometer, a temperature sensor, a camera, an indicator, a haptic device, a GPS receiver, a gyroscope, a display, a tactile sensor, a galvanometer, a speaker, or a motor.

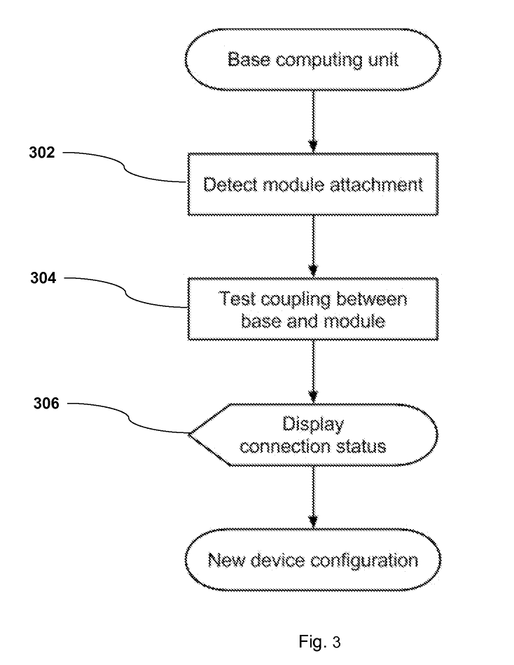

The diagram in FIG. 3 displays a procedure for user assistance following the attachment of an expansion module to the module connection port 106 contained in the computing base 100, which the master processor 114 may be configured to perform. Once the module is detected 302, the connection between the module and computing base is verified 304, and the connection status is then communicated to the user 306. In conjunction with this procedure, the module may be initialized or otherwise integrated into the software system controlling the smart base. For example, an instance may be created, containing a serial number given by the expansion module's memory or an address or register, and the type or class of extension module may be communicated to the user. Examples for such user interfaces include displays, speakers and other outputs, either directly contained in the smart base or as part of devices that may be paired with it, as will be explained later.

The invitation to create a wearable electronic device through selecting and inserting expansion modules may offer an educational value and familiarize the user with the experience of creating an electronic device for a purpose or specific function.

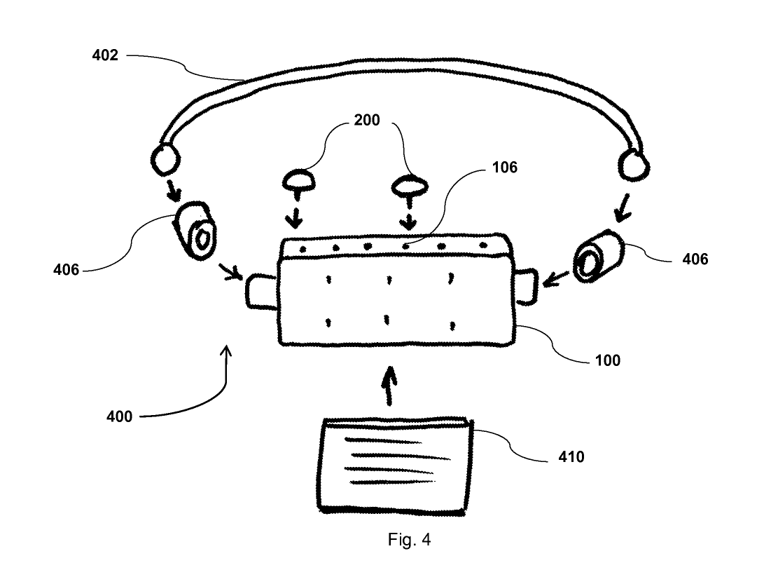

In one embodiment, the computing device has a band attached to it, making it a wearable device. As described and depicted in FIG. 4, the wearable computing device, wearable device, decorative computing device, or assembled computing device 400 may comprise a plurality of sections, mechanically joined, falling generally into two classes active sections and passive sections. Referring to this embodiment in more detail, the wearable computing device 400 comprises a band or flexible band 402, such as a wristband, connected to a computing base 100 via segment connectors or mechanical connectors 406. The computing base 100 may be extended by at least one expansion module 200. A user interface, such as a display 410, may be connected to computing base 100 either permanently or through expansion module connection ports 106.

The present disclosure, therefore, provides for “smart jewelry” that incorporates separate functional components, such as the computing base 100 and associated expansion modules 200, and the aesthetic components, such as band 402. The functional components, such as the computing base and expansion modules, may appear non-obtrusive and universal. The aesthetic components may be changed frequently by the user. Their use may follow rules for certain components. Within these rules, users may be given flexibility in controlling appearance in color, shape, material. The jewelry character may be preserved by the compactness and unobtrusiveness of functional components, which provide the computing functionality. Mechanical connectors 1100 may be standardized so that decorative element can be changed with ease. One use of such functionality is the ability to add and/or change components to match any outfit and style.

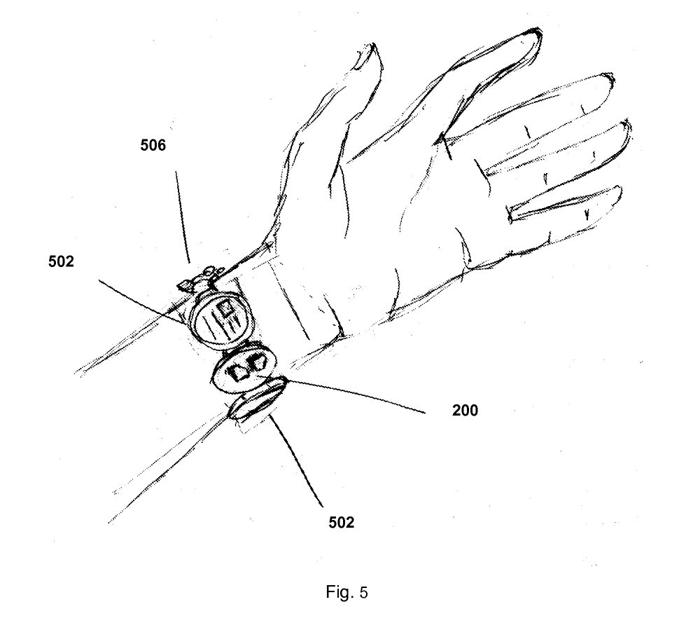

Referring now to an alternative embodiment as shown in FIG. 5, the active section 502 may comprise an arrangement of expansion modules 200 and single or multiple computing bases 100. Active sections may have section couplers, or coupling devices 506 at the ends to connect to passive sections or other active sections. Multiple active sections may be coupled. They may function independently or be connected through an electrical bus. In a particular embodiment, active sections have an electrical bus, which may be configured to be associated with a master processor or memory in another active section. In one example, such an active section may not have disposed within a master processor.

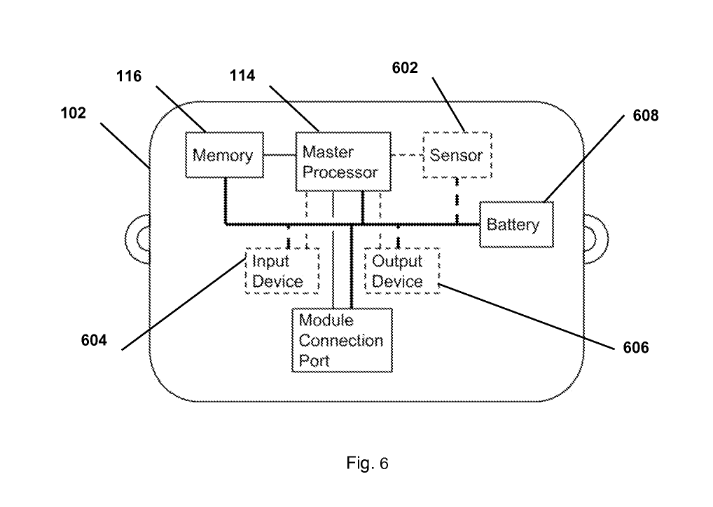

Referring now to another embodiment shown in FIG. 6, the computing base may comprise additionally housed, a sensor or sensors 602, any number of input devices 604, any number of output devices 606, and batteries 608. Such elements may be coupled directly to the master processor or connected to the electrical bus. In different embodiments, the computing base may contain a functional component such as a wireless transceiver, an accelerometer, a temperature sensor, a camera, an indicator, a haptic device, a GPS receiver, a gyroscope, a display, a tactile sensor, a galvanometer, a speaker, or a motor.

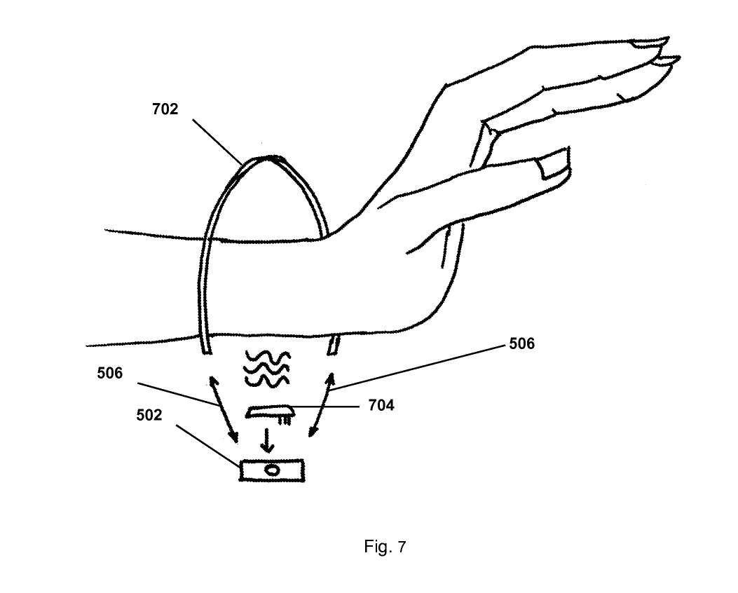

Referring again to the embodiment shown in FIG. 7, sections of either the passive type 702 or active type 502 may be joined with coupling devices 506. This coupling can be opened and closed by hand by the user to allow for exchangeability of the decorative or passive section. In one embodiment, the coupling device is considered reversible where connectors can be coupled to other connectors in any orientation.

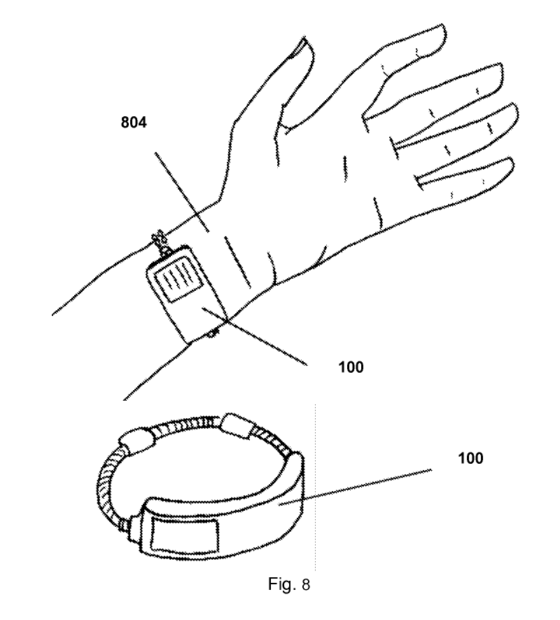

In one embodiment, the coupling device has geometry to restrict attachment of predetermined modules to predetermined attachment locations on the computing base. For example, a skin conductivity sensor 704 could only be located on the computing base where it could make direct contact with the skin. Referring now to FIG. 8, a proposed layout of the device shown in FIG. 8b offers additional privacy in using the device as shown in FIG. 8a, and further allows for the display of the decorative, passive section, a design can suggest wearing the computing base 100 on the palm side of the wrist 804.

In one embodiment, section couplers contain module connection ports. This could be advantageous for connecting multiple active sections or for connecting decorative elements which provide the electrical functionality of an expansion module. In one particular example, the couplers provide electrical connections for transmitting DC power and data through the connection. This may be achieved through an electromechanical coupling.

To overcome problems of device rotation through slipping and dislocation, the configuration of active and passive sections may be such that the weight distribution places the heavy components, for example the battery, at or close to the naturally downward-facing side of the pronated wrist, commonly posterior to the ulna bone. Another solution may be found in incorporating a strap or hook, which extends to the upper side of the wrist, and which positions the computing base or fastens it to the desired orientation. Additionally, the backside of the cover may be large and either flat, following the natural contour of the wrist. A rubber band can may be attached in conjunction with a sensor that requires a tight fit (e.g. skin conductance, pressure for heart rate or breathing).

In one embodiment shown in FIG. 8b, a given curvature determines the shape of the active section 502. A display 410 can be integral to the computing base 100. To enhance easy visibility of the display given a natural movement of the hand, said display can be located at a 90° to 180° angle from the center of gravity of the device.

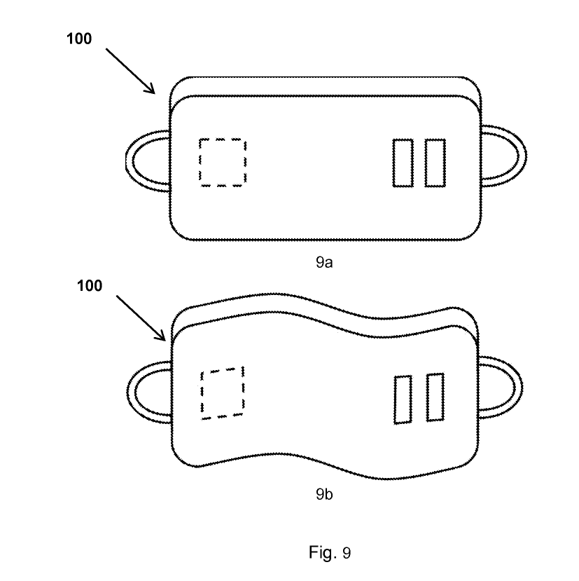

Referring now to FIG. 9, in a different embodiment, the computing base 100 is not fully rigid, but flexible. This can be achieved by using techniques commonly summarized as ‘printed electronics’ to manufacture circuits and displays that are large enough to affect the bending radius of the active section. In further detail, such patterns can be printed, etched, or otherwise deposited on flexible polymer films using techniques known as soft lithography, such as nano-imprint lithography, micro-flexography, or microcontact printing. This construction allows for the computing base to go from an undeformed state as shown in FIG. 9a to a deformed state as shown in FIG. 9b without breaking.

Referring now again to FIG. 4, detachable expansion modules 200 can be used to extend the functionality of the computing base. The connection of these modules with the base can be achieved through a connector. Such connectors can comprise functional features including: registration features to locate the module with respect to the active band segment, mechanical retainers to prevent the accidental removal of the module, and a plurality of electrical connectors.

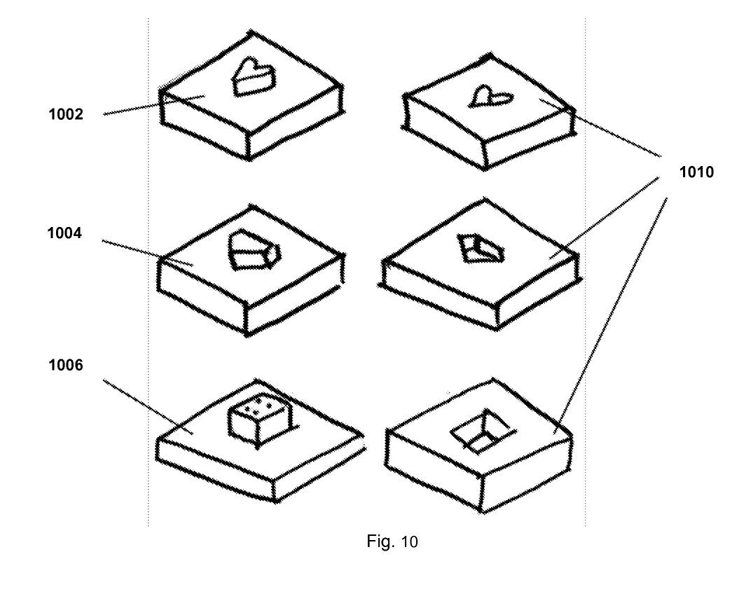

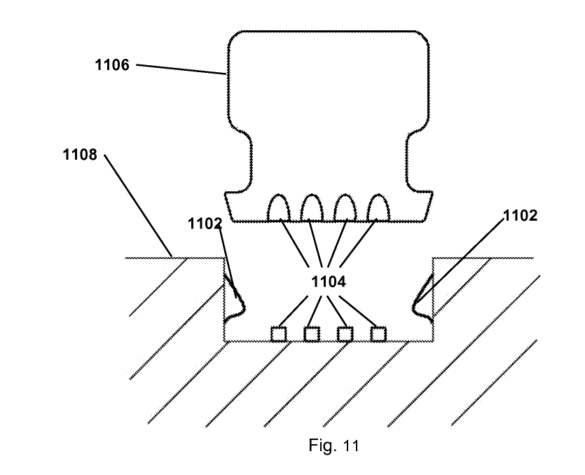

The shape of the connector can provide decorative and alignment functions, as depicted in FIG. 10 In one exemplary embodiment, the module connector is given the shape of a heart 1002. In one exemplary embodiment, the module connector is given the shape of an isosceles, axially symmetric pentagon 1004. Alternatively, the connector can be bi-axially symmetric to allow for multi-orientation placement 1006. The connector can be a male 1008 or female 1010 type at the expansion module interface.

In one embodiment, module connectors are directional and the correct orientation is suggested by the shape of the connector. This may prevent against incorrect orientation and facilitate assembly.

The connectors may have features to keep the module mechanically attached to the connector to prevent accidental removal. In one exemplary embodiment, an arrangement of mechanical detents and locking springs elements prevent unwanted disconnection of the compact computing base and an expansion module. In one exemplary configuration, the connector is undercut allowing for mechanical engagement of the connector. In one exemplary embodiment, an arrangement of magnets retains the module on to the connector. The connector can facilitate assembly through an easily identifiable orientation.

Referring now to FIG. 9 one configuration is shown wherein the electromechanical connector 1100 comprises two sets of functional features, mechanical retainers 1102 to prevent the accidental removal of the module and a plurality of electrical connectors 1104. Such contacts provide for electrical power and communication connections from the functional section to the modules.

In one exemplary embodiment, the electromechanical connection has distinct male 1106 and female 1108 components. In one exemplary embodiment, the connector is cylindrical allowing for rotation of the module. In one exemplary embodiment, the connector is semi-spherical allowing for rotation of the attached module.

The electrical function of the contacts can be fixed based on their position relative to the functional section to the module. The connector may comprise at least three such contacts: one for power, positive voltage, or voltage line, another for a zero-volt reference, or ground line, and a third for data signaling to the module, or data line. Multiple data lines or voltage lines may be present. The size and arrangement of the contacts can be varied based on the power requirements for the modules, or to predetermine where on the computing unit a certain type of module needs to go (e.g. certain sensors, which need to be attached on the skin-facing side). Full power can be supplied to the connector via a control circuit for the prevention of a short-circuit.

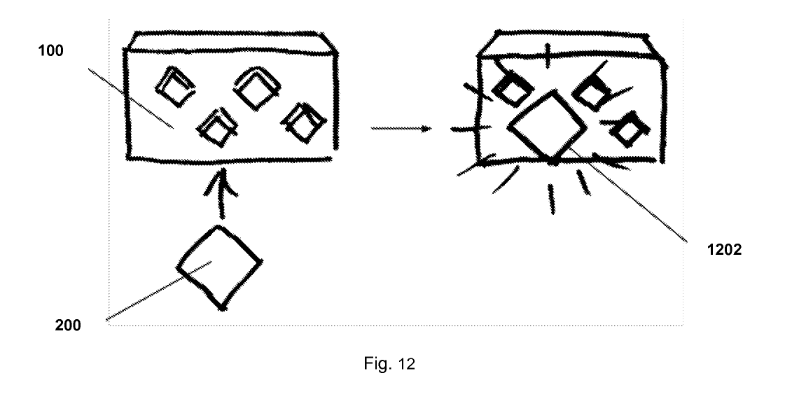

Referring now to FIG. 12, a useful feature in an embodiment of the presented invention is assisting the user with instant feedback upon successful expansion of the computing base 100 with an expansion module 200. The expansion modules can be equipped with a mechanism or circuit, which allows them to signal or indicate the successful connection to the base, as shown in 1202. As soon as the expansion module 200 is connected to the computing base 100, a successful connection is indicated instantly, for example by a light source 1202 contained within the module or base.

This signal can be enabled through an electric circuit that is disposed in the computing base. This circuit can be an additional circuit, for example with minimal energy requirements to facilitate device compactness. In one example, a capacitive network is used to detect a rising edge in the signal through a closed circuit. In another example, software is used to detect and communicate the established connection between expansion module and computing base.

Signaling can be visual, as well as audible or tangible; and can be for a limited time or as long as the connection is in place. The signal can vary for a mere hardware-side connection and for a confirmed digital integration of the expansion module with the master processor.

Connections between the expansion modules and the compact computing base may consist of a set of connections for providing DC power to the expansion modules and another set of connections for digital communications with the expansion module.

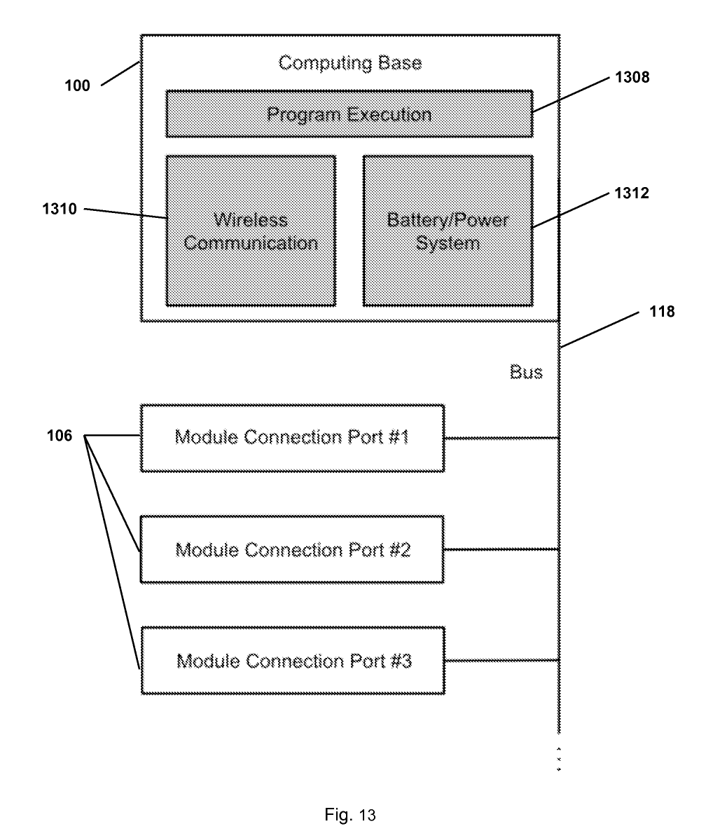

Referring now to FIG. 13, a block-diagram represents an arrangement, connection and functionality of the computing device including the computing base and the expansion modules. An electrical bus 118 couples to the aforementioned module connection ports. The electrical bus comprises a set of lines, or conductors, carrying data or control signals within the computing device, to which different parts of the system are connected in parallel. The electrical bus is configured to allow some module connection ports on the electrical bus to be left unoccupied. The module connection ports 106 and the computing base 100 utilize the communication connections on the electrical bus for the exchange of digital information. The expansion modules comprise sensors and indicators whose function is directed by the computing base.

In one group of embodiments, the lines of the electrical bus may be configured as a physical layer to support communication between the elements utilizing any number of existing protocols including, but not limited CAN, RS232, I2C, UART, UniPro, or other protocol.

Referring still to FIG. 13, the computing base 100 comprises capabilities for executing programs 1308, which may be altered by the user, systems for wireless communication 1310 including wifi, Bluetooth, NFC, and XBee. The computing base may also comprise a battery system as a power source and control circuitry 1312 to provide DC power to the computing base and the expansion modules. The computing base may have a display integrated as well. Further, the applications, routines or programs may be implemented on the computing base using any programming language whether now known or later developed, including, for example, assembly, C, C++, Python, BASIC, Wiring, and Java, whether compiled or uncompiled code; all of which are intended to fall within the scope of the present invention. In another embodiment, the battery and/or associated control can itself comprise an expansion module.

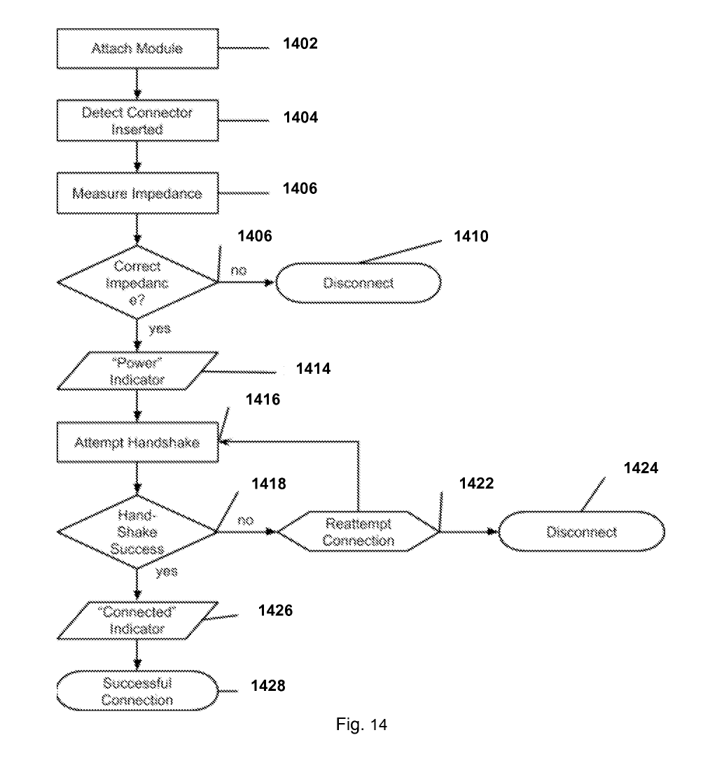

Referring now to FIG. 14, an embodiment of the expansion module to computing base connection process is shown as a flow chart. The connection scheme is to ensure that an appropriate module is being connected and to inform the user of the status of the connection process so that troubleshooting may be aided. The connection allows the system to know which expansion modules are connected, that the connections are appropriately made, and the attachment location of the modules. The connection scheme may also provide for a system to prevent the power connections from being shorted. Notably, for the avoidance of doubt, the inventions are not limited to processes, and/or algorithms implemented in accordance with the diagram of FIG. 14. Such a diagram is merely exemplary.

Referring still to FIG. 14, the connection checking process is initiated by the physical engagement of the compact computing base and an expansion module 1402. The action of making the connection activates circuitry to indicate the mechanical mating of the components 1404. In one embodiment, attaching the expansion module closes a normally open circuit to indicate the mechanical mating of the components.

The scheme then proceeds by measuring the impedance of a characteristic circuit 1406 to confirm that closure of the circuit was the result of a proper module inserted. The measured impedance is checked against a known range of correct values for an expansion module 1408. If the measured impedance is not within appropriate bounds, the power circuits may be disconnected from the expansion module and the routine is terminated 1410.

Still referring to FIG. 14, a measured impedance that fits in the appropriate bounds is considered a successful connection 1412. Full power is applied to module and a notification, which can comprise visual, audible, or tactile sensations, is given to the user to indicate successful connection 1414. The application of power enables the digital logic circuits enabling digital communication between the expansion module and the compact computing base. To check the fidelity of this communication, the compact computing base initiates a digital handshake 1416. The handshake can comprise a simple query of the expansion module by the compact computing base. Successful digital communication is defined by the expansion module returning an expected response to the initial query 1418.

Still referring to FIG. 14, the absence of a return message from the expansion module to the query from the computing base, or the return of an inappropriate response, comprises a failure of the handshake 1420. Upon such an event, the computing base can set forth another attempt to confirm digital communication with the expansion module by dispatching another digital handshake 1422. This process can be repeated until digital communication is established or until a predetermined number of additional handshakes has been reached. In one embodiment, the predetermined number of additional handshakes is stored in the memory associated with the master processor. If communication is not established, the power to the expansion module may be disconnected 1424 and the process terminates resulting in an unsuccessful connection. The user is informed of the process termination. The notification can be via visual, auditory, tactile, or other signaling.

Still referring to FIG. 14, a successful handshake confirms that the connection between the expansion module and the computing base is fully stable and operational. An indication of good digital communication, which may comprise a visual, audio, or tactile signal to the user, is activated 1426. Finally, the connection process is complete. The expansion module and the computing base interact according to their programming 1428.

In one embodiment, the successful pairing of the expansion module and the computing base activates mechanisms that alert the user to the expanded capability of the assembled system and offer assistance in utilizing said capability during the process of generating a new program to execute on the computing base.

This assistance can include offering the user an exemplary module integration scenario with or without specific parameters. For example, a suggestion can be to alert the user if an inserted sensor measures value outside certain range. Other suggestions may include: running executable code stored in an inserted memory module; collecting data from an inserted sensor on local memory; sending data from an inserted sensor to existing network; and sending signals, such as generated signals, to an inserted indicator.

Furthermore, the computing device may be configured to suggest potential functionalities to the user. Such potential functional ities may comprise configurations that are possible with a set of components that are available on the device. For example, once an accelerometer is inserted, potential functionalities may include a pedometer, a tilt sensor, an impact sensor, and a gravity sensor. These potential functionalities may be retrieved from or compiled into a list, table, database, or array, stored in memory associated with computing device, server, or other medium. Information may be retrieved from a similar medium, which configures the master processor to perform functions that may be selected by the user.

The enumerated list of the potential functionalities may be stored in memory in the device itself, or queried and downloaded from a wireless network from a server or with a wired or wireless connection to another device. This download may be triggered by the successful identification of an expansion module and settings in the system may allow the user to set conditions for this behavior.

In one embodiment, the user selects a desired functionality prior to assembly. Options may be available to the user from which to select a desired functionality, which may be stored on a server or on a computer readable storage medium. Once the user has selected a desired functionality, an interface associated with the computing device, or a coupled host device, may prompt the user to connect certain expansion modules in order to achieve a desired functionality according to a recipe, or a predefined final configuration of expansion modules. Recipes may be retrieved from a coupled server, from another device, or retrieved from computer readable storage media attached to the device. In a particular embodiment, the storage medium is attached through a module. With the recipe may be retrieved information to configure the master processor to perform certain functions with the connected hardware in order to deliver the desired functionality to the user.

A software, application or web-based platform can be used to provide a graphical interface to the user and to allow for the assisted generation of code that runs on the controller embedded in the compact computing base. Said programming application may be executed on a computer or portable communication device such as a smartphone or tablet computer as a host device.

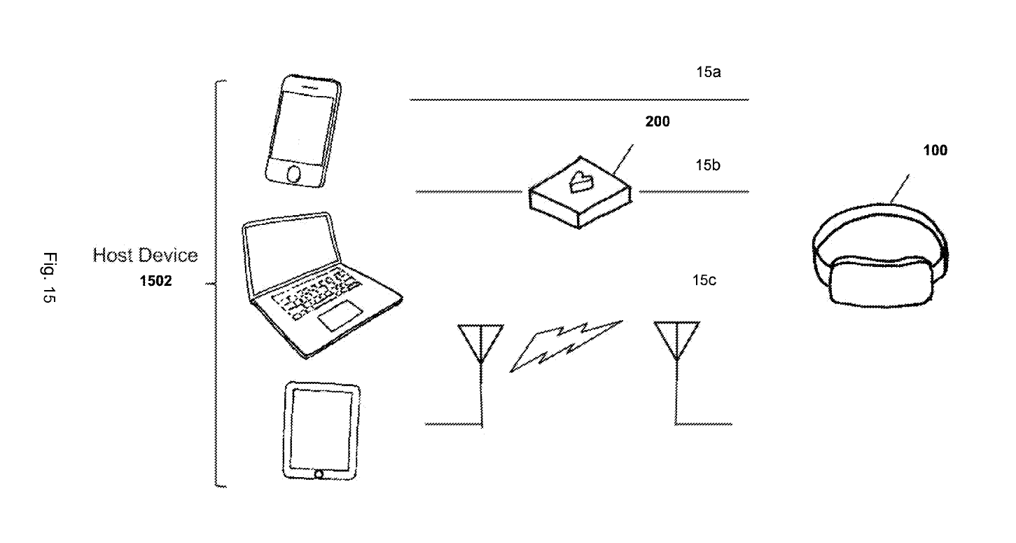

Referring now to FIG. 15, the host device 1502 can connect to the computing base 100 either directly 15a or, as in 15b, through an expansion module 200. Further, the connection can be established through Bluetooth, NFC, wifi, audio port, proprietary connection or any other wireless means 15c. All communication mechanisms, techniques, and architectures are intended to fall within the scope of the present inventions.

The application can offer the means store a user's phone number, email address, or social network username, and may associate it with an individual.

Further, the application can have means to generate an instance for said user, and to generate an instance for the device, in ways that allow multiple devices per user or multiple users per device.

The application may further accept that the user assigns a name to the device or to its instance, globally or specific to a software configuration and/or a hardware configuration. More than just a name, the software can allow the user to assign a story or application to given configuration. A ‘story’ may refer to a real use case, a fictional scenario, or a development chronology. The narrative of a story may be a symbolic summary, a detailed description, or a combination thereof. The story may link the configuration to an application. A specified format can be required to standardize the elements of the story (such as people, places, objects, commercial products, or use cases) for further distribution or processing of the story components within social networks (e.g. Facebook Graph API) or a cloud database. Such additional processing may include processes for recognizing brand and product trends, location trends, trends of social interaction, etc. In one particular embodiment, the results of said processing can be used to create a reward system for achieving new functionalities of the device.

This story can accept the addition of images or videos. Images or videos can be uploaded through computer, mobile communication device, online interface, or an external source. They can be a copy from an external source or contain a link to an external source. This external source can be a server. It may permit the administration of images or videos. The addition of images or videos can be limited to one or several external sources, and it can be limited to a specific server.

The user can be given the option to publish said story or elements thereof through an online platform. Publication can be possible through a different, more specific or more general format. Elements of the configuration itself can be published in an original or modified format.

Social networks and derivative instruments may be utilized to share stories with friends and make configurations and applications accessible to a limited group of people.

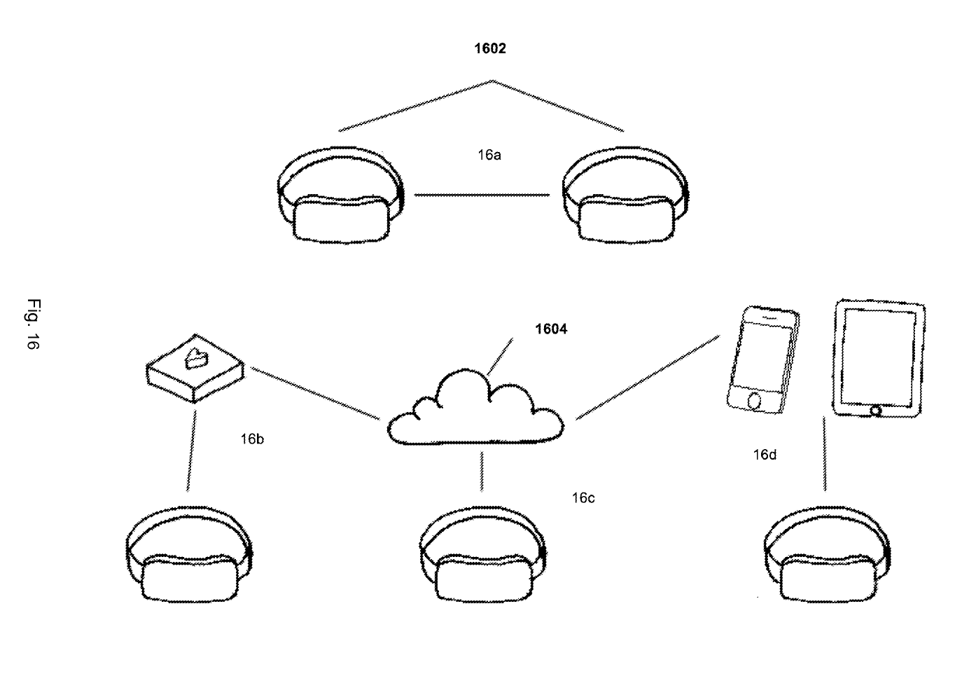

FIG. 16 shows different embodiments of networks that can include the computing device of the present disclosure. The computing device or wearable device can be part of a network of devices 1602, formed through a connection with the computing base using wireless connection technologies as shown in FIG. 16a. The device can form a bridge between other such computing devices or wearable computing devices and other electronic devices. The device can be part of a network comprising other such computing devices or wearable computing devices and other electronic devices.

Ad-hoc networks can be formed to allow for applications that entail device-to-device communication as shown in FIG. 16a. The network of devices may be virtualized through the internet or other cloud-based resource 1604. The controller in the computing base may connect to the cloud through a specific expansion module as shown in FIG. 16b, directly as in FIG. 16c, or as relayed through another device connected to the network as shown in FIG. 16d.

Connecting the computing device to a network and to other such devices may allow the user to select configurations that include other devices. For example, a conditional action may be executed on one device following a trigger on another device. This may be used to create configurations that allow users to communicate or to gather information about one another.

The computing base, and thus the connected host device, detects the connection of the new module and automatically integrates it (i.e. install drivers, create a variable, suggest blocks in programming interface etc.) and may congratulate to the successful creation of a device by its chosen configuration.

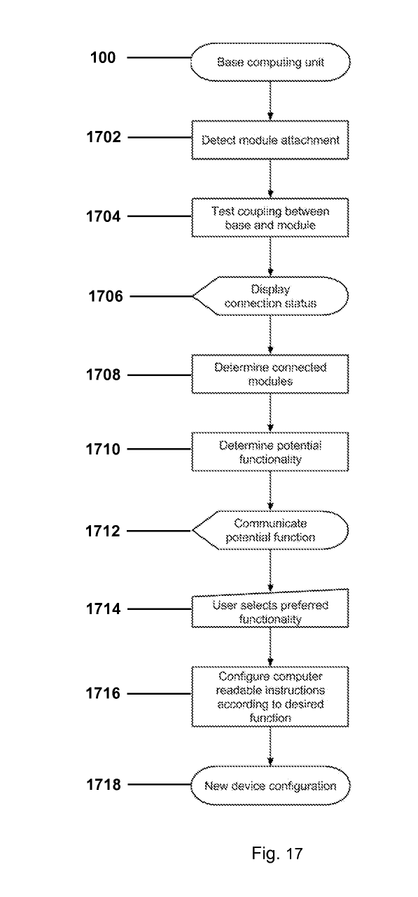

Referring now to FIG. 17, an embodiment of the process for guided assembly of a device is shown. The computing base 100 is configured to detect the attachment of an expansion module 1702, test the coupling between the master processor and the expansion module 1704, indicate to the user the results of the coupling testing 1706, determine the type and attachment location of the connected modules 1708, determine the potential functionality of the assembled device from the configuration of the expansion modules 1710, indicate the potential functionalities to the user 1712, receive input from the user selecting the preferred functionality 1714, and configuring the computer readable instructions to perform the selected function 1716, thus resulting in an expanded device with a desired functionality 1718.

In one embodiment, the user assembles the device so that it is configured to operate with a predetermined functionality. In this fashion, the device guides the assembly by indicating the type and attachment location of expansion modules to be added or removed from the functional base through the aforementioned ‘recipe’. The device gives further feedback as assembly progresses to indicate to the user if, for example, the master processor is in successful communication with the expansion module.

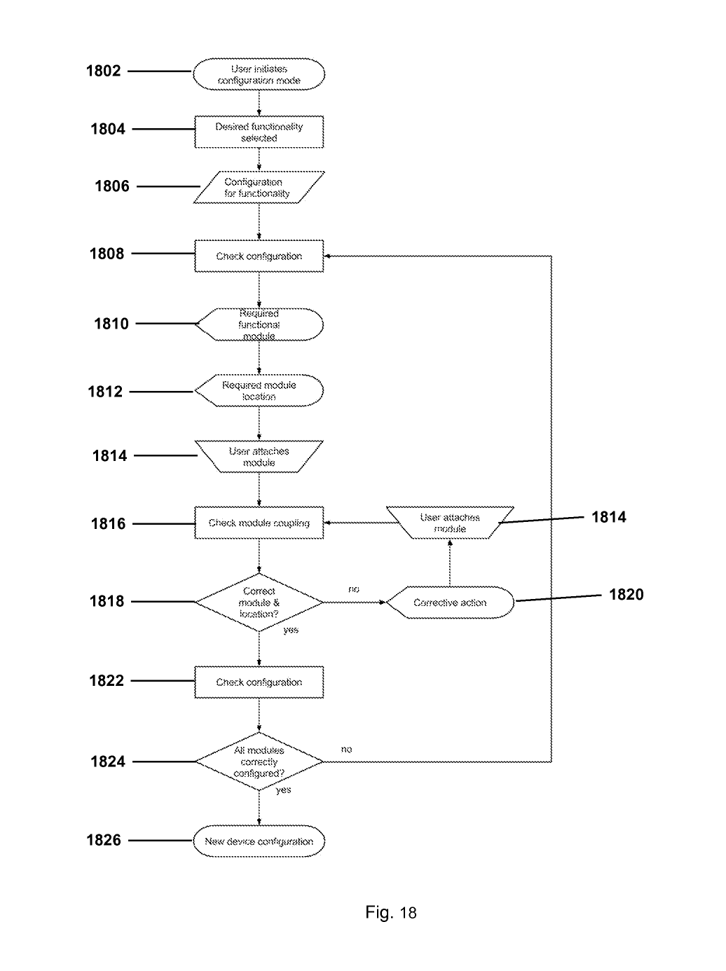

Referring now to FIG. 18, an embodiment for the guided assembly of a modular wearable computing device to achieve a predetermined function is shown. A user is invited to place the wearable computing device into the configuration mode 1802 and select a desired functionality of the device 1804. The desired functionality has a corresponding configuration of the master processor and master memory as well as a corresponding arrangement and types of expansion modules. These configuration data are determined for the desired function 1806 as selected by the user.

Still referring to FIG. 18, the configuration of the attached modules is checked against the target configuration 1808. The device indicates to the user the expansion module to be added 1810 and the attachment location where the expansion module should be connected 1812. The user is guided by these indications to alter the configuration of the attached expansion modules 1814. At this point, the device checks that the module is appropriately attached and coupled to the master processor 1816. If the expansion module is not properly coupled to the base computer 1818, the device may indicate a corrective action to adjust the coupling 1820.

Referring still to FIG. 18, if the coupling with the expansion module is successful 1818, the device again checks the configuration of all the attached expansion modules against the target configuration to achieve the desired function 1822. If there remain deviations from the desired configuration 1824, the device further indicates which modules are to be added 1810 and where 1812. If the configuration of the device wholly matches the desired configuration 1824, the device is assembled to achieve the desired functionality 1826.

In another embodiment, the computing device generates potential functionalities upon user input. An input from the user triggers the master processor to detect the type and attachment location of the connected expansion modules. The user can then select a preferred functionality from this set of feasible functionalities. The selection of a particular functionality configures the master processor to receive inputs and control the outputs of the device to achieve the desired functionality.

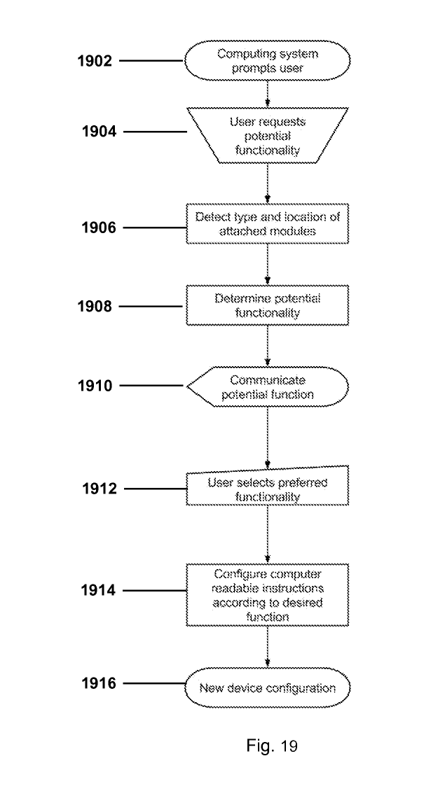

Referring now to FIG. 19, according to this embodiment, computing device prompts the user for an input 1902. The user indicates that the potential functionalities should be evaluated 1904. If so commanded by the user, the device determines the type and, if applicable, attachment location of the newly added module 1906. With these configuration data, the potential functionality is determined 1908. The potential functionalities are indicated to the user 1910, for example in form of a list, table, or array; retrieved from a remote server, local memory, or other source as explained earlier. The user indicates the preferred functionality 1912. The computer readable instructions are then configured for the device to operate according to the desired function 1914. This results in a new device configuration and new device function 1916.

In another embodiment, the computing device continually generates potential functionalities as expansion modules are attached or removed from the computing base. As expansion modules are added or removed, feasible device functionalities are generated and displayed to the user. This way, the user can understand the effects of adding or subtracting certain expansion modules. The selection of a particular potential functionality may configure the master processor, for example to receive inputs and control the outputs of the device to achieve the selected, or desired, functionality.

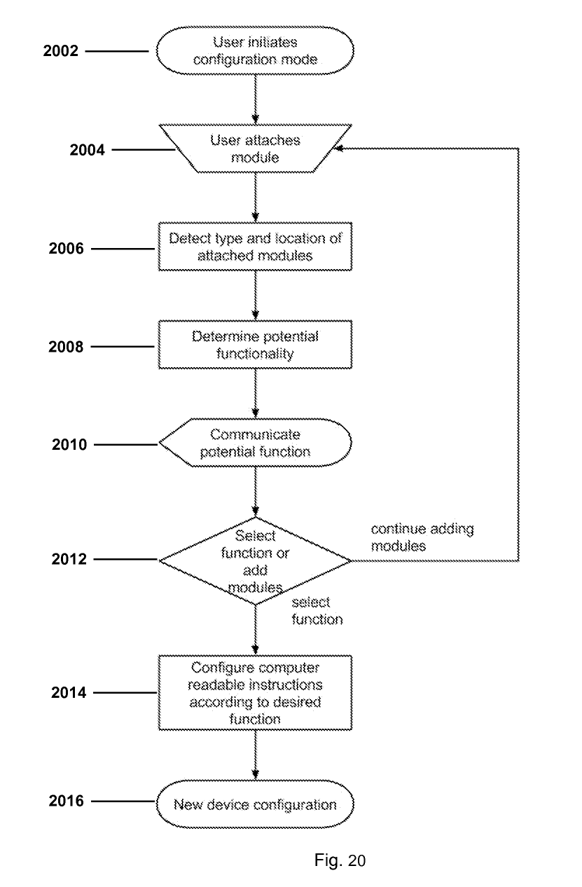

Referring now to FIG. 20, according to this embodiment, the process begins when the user initiates the configuration mode of the device 2002. The process is triggered by the attachment of an expansion module to the computing base 2004. The device determines the type and attachment location of the newly added expansion module 2006. With these configuration data, the potential functionality is determined 2008, for example in form of a list, table, or array; retrieved from a remote server, local memory, or other source as explained earlier. The potential functionalities are indicated to the user 2010. More expansion modules can be added, or a preferred functionality can be selected from those indicated 2012. The computer readable instructions are then configured for the device to operate according to the desired function 2014. This results in a new device configuration and new device function 2016.

Potential functionalities can be retrieved from various sources. In one embodiment, an enumerated list of potential functionalities for different configurations of expansion modules is stored on computer readable memory disposed within the base housing and coupled to the master processor. The master processor, upon determining the configuration of the device based on the type and attachment location of the attached expansion modules, queries the list of functionalities for the current configuration which returns the possible functionalities which are then presented to the user to select the preferred functionality.

In another embodiment, the enumerated lists of potential functionalities are stored on a remote server wirelessly coupled to the master processor. The master processor, upon determining the configuration of the device based on the type and attachment location of the connected expansion modules, queries the remote server for the current configuration which returns the possible functionalities which are then presented to the user to select the preferred functionality.

In another embodiment, the enumerated lists of potential functionalities are stored in computer readable memory disposed in at least one expansion module attached to the computing base. In this arrangement, the master processor is coupled to the expansion modules via the electrical bus. The master processor, upon determining the configuration of the device based on the type and attachment location of the coupled expansion modules, queries the memory in the expansion modules for the current configuration which return the possible functionalities which are then presented to the user to select the preferred functionality.

In another embodiment, stored information, such as a saved configuration, may be distributed across memory in multiple extension modules. In this case, the master processor may retrieve the information once all its parts are connected to the data bus coupled to the processor. An advantage of such distributed memory would be increased compactness, which may allow for smaller components, allowing for a more compact wearable electronic device.

Configuration software allows the user to give said device a name and tell a story as described previously. For example, there can be a link to YouTube, Twitter, Instagram, Tumblr, Facebook or any other public network currently existing or created in the future.

The user can choose to see what their friend made out of a device like this, e.g. which application they intended it for. Friends can be able to exchange software and/or configurations. The story (text, photos, video(s) etc.) can be shared through public platforms and networks, such as the ones mentioned above.

In one particular embodiment, the computing base consists of an Arduino-based microcontroller (e.g. ‘Femtoduino’) and is powered by one or more coin cell batteries (e.g. Lithium cells CR1220 3V). Further, a user interface can be provided using a display (e.g. 0.9 inch OLED display), a physical button, and/or a touch sensor. These inputs and outputs may be rigidly attached to a lid. The connections between the components mounted to the lid and to the base of the device may be created in a way that allows the user to swap out the lid and thus the user interface in order to customize the modes of interaction with the device. Examples for the mechanical fixation of the lid on the base frame include clips, flaps and press fittings created through rubber or other elastic material between the pieces of the enclosure.

A touch sensor, such as mentioned in the embodiment described above, can be a selectively metal-coated flexible polymer film. It can sense the position of a finger or other conductive element along an axis using an intertwine comb pattern, or digitally detect the presence of a conductive element.

Such a touch sensor can be mounted on the enclosure, as described above, using an adhesive layer or by applying the conductive traces directly; or on a flexible bracelet.

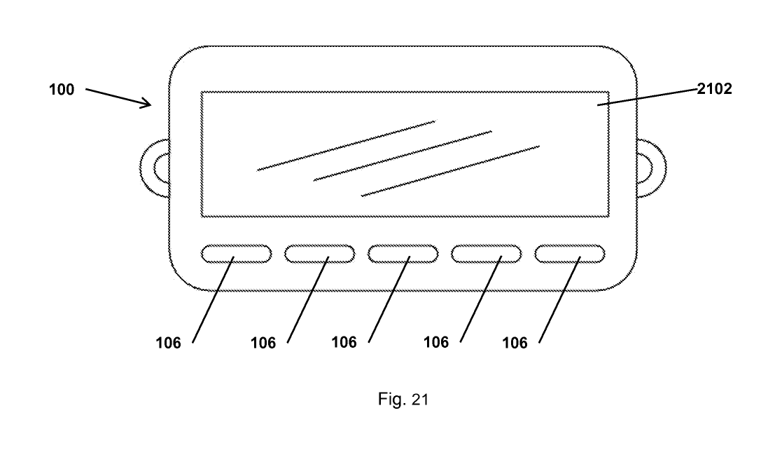

In one particular embodiment, as shown in FIG. 21, the computing base 100, has several module connection ports 106 and a display 2102.

The functionality of the assembled and programmed computing device can be one of the following: give information on proximity of known radio-enabled devices to infer to proximity of ‘friends’, the mood of the wearer or of the wearer of any coupled device using temperature sensors, accelerometers, heart rate monitors, skin conductivity etc. The ‘mood’ of the device wearer or the wearer of a paired device can be shown on a display using symbols, such as emoticons, or using any visual, audible, tactile or other actuators. Another functionality may include the generation of a certain type of text sorted by categories and selectively synchronized with a server.

In specific embodiments, the enclosure can be plastic, metallic, bio-organic material, or coated plastic, white or colorful, approximately 70 mm by 25 mm by 8 mm in dimension, or half as much or anything in between, with rounded corners. A display can be attached to the enclosure and receive signals from the master processor.

As exemplarily depicted in FIG. 4, band 402 can be a piece of jewelry, e.g. a series of interconnected loops of metal or other material to form a chain. The section can comprise a plurality of such chains.

In another exemplary embodiment, the decorative section comprises a solid material strap which may be made of leather, rubber, elastopolymer, or other synthetic or natural material, for example to form a bracelet. Alternative materials for such a band include studded leather, gold charms, or colored plastic. The band may additionally be adorned with other decoration. The decoration can also comprise woven material of textile of natural or synthetic origin. A variety in available materials may increase the range of styles the user can apply.

In one embodiment, the device can be worn in different ways by introducing further modularity through the non-functional, decorative part of the device. Thus, in one embodiment, the system permits for conversion of a wearable device into another type of wearable device, such as a bracelet, necklace, clip, or belt. The computing base can be equipped with mechanical connectors for the attachment of such a band or looped material. These connectors could be jewelry connectors or specific clasps.

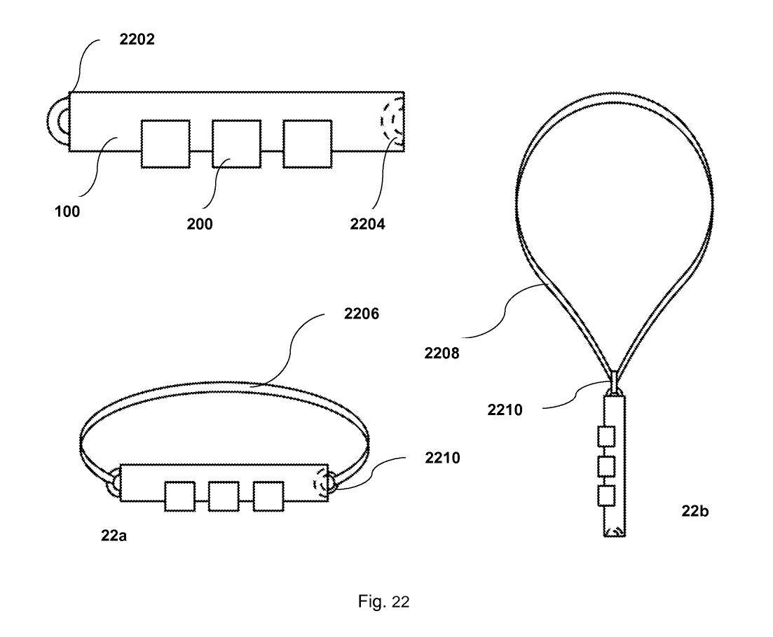

Examples for different decorative attachments are given in FIG. 22. In one embodiment, the computing base 100, to which expansion modules 200 may be attached, may have different mechanical connectors 2202 for attaching a bracelet or a necklace, where at least one second connector 2204 is hidden to make it unobtrusive, unobstructed or compact, when it is not used in a certain mode of wearing. An example is when the device is worn as in a necklace and only one mechanical connector is attached, as compared to a bracelet with a band attached to two mechanical connectors at two ends of the device. In one example shown in FIG. 22a , a band 2206 may be attached to two connectors so the device may be worn like a bracelet. In one example, a loop 2208 may be attached to only one connector so the device may be worn like a necklace or different type of bracelet as shown in FIG. 22b. These are specific examples and other combinations, and greater numbers of mechanical connectors, may be possible. Additional coupling components 2210 may be added for certain modes.

In one particular embodiment, the device enclosure has one or more holes on either side to support mechanical connectors. In one embodiment, a clasp, such as a lobster clasp, is attached to one side. On the other side, a chain extension can be attached, such as usually found in bracelets, to allow the wearer to make adjustments in length. With this, the device could be inserted in bracelets that have a similar clasp, which the user may already have and may want to use in conjunction with an electronic device.

In another exemplary embodiment, the decorative element comprises loops joined with Brunnian links bridging two connectors. The decorative element may consist of a first segment having a plurality of holes and a second segment with an engagement mechanism to allow fastening to one or more of the holes in said first segment, to allow for an adjustment of the length of the segment to more appropriately fit the wearer. In one particular embodiment, the device may be a fused bracelet, a bangle, such as a round or oval bangle, a cuff, an open, or a hinged bangle. The sections can be of differing widths. Sections of differing widths can be joined to form one device. The sections can be of different lengths to achieve decorative and functional purposes. The assembly can comprise any number of the constituent bands to allow for the creation of devices of different lengths.

In one embodiment, the invention allows for integration with existing jewelry. A variety of jewelry clasp types can be used to connect the functional section (the compact computing base with inputs and outputs) to the decorative section (jewelry bracelet).

Exemplary jewelry clasps can include common jewelry fasteners such as trigger clasps, fine jewelry fasteners such as bolt rings, T-bar fasteners, toggle clasps, and hooks, such as S-hooks and fish-hooks. Less common examples include a male-female connector, where the male part is locked using a spring, or one where the male part is a threaded stud and the female part is a tapped bore, where either may be hidden in beads at the ends of the strand.

To be used with longer bracelets, one side of the device can feature a T-bar fastener or a fine chain, to attach to any part of an existing bracelet.

More specific connectors or clasps may use bolts, springs or magnets to define the orientation of the device relative to a band, thus overcoming the problem of unknown orientations of the device relative to the user's skin.

In another embodiment, the computing device can be inserted into a recess in a band. An advantage of this embodiment is that no mechanical connector is necessary on the housing of the computing base itself. Bands with such a recess may comprise bracelets, necklaces, hairbands, belts, clips, other accessories, or components thereof. The recess in the band can have the shape of the computing base or of a protrusion that the smart base may have. It may be made out of an elastic material such as rubber, and have an undercut to offer a mechanical locking mechanism between the recess in the band and the computing base or a protrusion thereof. Alternatively, there may be a protrusion in a band to match a recess in the computing base.

Applications for such modular wearable electronic devices are diverse. Certain aspects may contribute to educational purposes, invite the user to create wearable electronic devices after their own ideas, and convey the experience of creating devices with specific functionalities or for specific purposes.

The described components may also be used to assemble medical bracelets, for example for the provision of health monitoring or emergency functionality, which looks just like a piece of jewelry. The assembled wearable electronic device may then serve as a wearable medical assistance that offers the wearer privacy and familiarity in its use. Potential wearers may include temporally or permanently medically impaired or elderly persons, where users also include nurses, families or friends who wish to define the functionality or appearance of a medical device for someone in need. Examples for medical bracelets and their functionality include storage, identification, notification, sensing and data collection, emergency communication, and emergency detection or remote notification.

Ease of exchanging decorative elements, and especially allowing for integration with existing jewelry or different accessories, may allow the user to combine the computing device in desired ways and adapt it to different needs, such as robustness while exercising or elegance while in certain social contexts.

Some aspects of this description have advantages useful even beyond the field of wearable electronics. For example, aspects could be used in technical fields such as wireless communication or mobile computing in general, such as modular phones or portable computers.

While this disclosure has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A computing device, wearable by a user, comprising:
a computing base including a housing;
said housing having at least one mechanical connector configured to removably secure the housing to one of an active and a passive section;
and a first module connection port mounted in the housing, configured to be removably coupled to an expansion module, and coupled to an electrical bus.

2. The computing device of claim 1, further comprising a master processor connected to said electrical bus and associated with memory that stores therein computer readable instructions.

3. The computing device according to claim 2 wherein the computer readable instructions cause the master processor to:
detect the expansion module when coupled to the first module connection port;
determine if communication between the master processor and the expansion module is successful; and
provide an output to the user to indicate successful communication between the master processor and the expansion module.

4. The computing base of claim 2 wherein at least one expansion module is removably attached and electrically coupled to the computing base through a module connection port.

5. The computing device of claim 2 having a plurality of module connection ports, wherein the computer readable instructions when running on the master processor additionally cause it to:
detect an attachment location on the computing base where an expansion module has been attached.

6. The computing device of claim 2 wherein said computing base further includes a tactile interface for a user coupled to the master processor, mounted in the housing.

7. The computing device of claim 2 further including a wireless transceiver in communication with the master processor, the wireless transceiver configured to connect to a wireless network.

8. The computing device of claim 2 wherein the computing base having a first and a second end, at least one of the first end and second end of the housing has a connector comprising of:
a mechanical connector for removable connection to a band;
at least one data line for coupling to the master processor;
a voltage line; and
a ground line.

9. A device according to claim 1, further comprising at least a second module connection port mounted in the housing, the second module connection port configured to be removably coupled to an expansion module.

10. The computing device of claim 1 wherein said housing further includes one or more indicators.

11. The computing device of claim 10 wherein said indicators comprise a display.

12. The computing device of claim 1 wherein said housing contains additionally a battery.

13. The computing device of claim 1 wherein said computing base further includes at least one functional component selected from a group consisting of: an accelerometer, a temperature sensor, a camera, an indicator, a haptic device, a GPS receiver, a gyroscope, a display, a tactile sensor, a galvanometer, a speaker, or a motor.

14. The computing device of claim 1 wherein the computing base having a first and a second end, at least one of the first end and the second end of the housing configured to be connected to a looped material.

15. A method for guided assembly of a wearable electronic device, said method comprising the steps of:
providing a modular wearable electronic device with a computing base;
detecting attachment of an expansion module to said computing base; and
indicating externally successful or unsuccessful communication between a master processor and the expansion module.

16. The method of claim 15 wherein the method further comprises detecting automatically a location on the computing base where an expansion module is attached.

17. The method of claim 15 wherein a final configuration of expansion modules is predetermined; and communicated to a user via indicators.

18. The method of claim 15 additionally including the steps of:
determining potential functionality of an assembled device from attachment location, number, and types of expansion modules attached to the computing base;
communicating to a user said potential functionalities;
sensing the user's preferred functionality; and
configuring computer readable instructions internal to the assembled device.

19. The method of claim 15 wherein the method of detecting an attachment of an expansion module to the computing base comprises the steps of:
establishing an electrical connection between said expansion module and said computing base;
measuring the impedance across the electrical connections of said expansion module;
automatically connecting a voltage line of said expansion module to a power source coupled to an electrical bus disposed within said computing base;
indicating the connection of said voltage line to a power source coupled to said electrical bus;
attempting a digital handshake with said expansion module initiated by a master processor disposed within said computing base;
determining if said digital handshake is successful;
indicating a successful handshake should one occur;
attempting a predetermined number of additional handshakes;
indicating a successful handshake should one occur;
determining an unsuccessful connection if a successful handshake does not occur within the predetermined number of additional handshakes;
indicating an unsuccessful connection; and automatically disconnecting said voltage line of said expansion module from said power source.

20. A wearable computing device, said device comprising:
a band, said band removably connected to a housing;
an electrical bus, said electrical bus disposed within said housing,
a master processor, said master processor coupled to said electrical bus,
said housing comprising:
at least one module connection port;
at least one expansion module, said at least one expansion module operatively connected to said master processor through said at least one port, said at least one expansion module selected from a group consisting of a sensing module, a user input module, an electronic logic module, a memory module, an output module; and a decorative module.
